(19) United States
(12) Patent Application Publication
(10) Pub. No.: US 2020/0148427 A1
(43) Pub. Date: May 14, 2020

(54) Storage Unit

(71) Applicant: Venkataramu Bangalore, Plano, TX (US)

(72) Inventor: Venkataramu Bangalore, Plano, TX (US)

(73) Assignee: Noble House Home Furnishings, LLC, Chatsworth, CA (US)

(21) Appl. No.: 16/681,114

(22) Filed: Nov. 12, 2019

Related U.S. Application Data
(60) Provisional application No. 62/767,449, filed on Nov. 14, 2018.

(51) Int. Cl. B65D 43/16; B65D 25/08; B62B 3/00; B65D 25/28; B62B 5/06; B62B 5/04; B65D 51/24

(52) U.S. Cl. CPC B65D 43/163; B65D 25/08; B62B 3/003; B65D 25/2841; B62B 3/005; B62B 5/06; B62B 5/04; B62B 3/006; B65D 51/242; B62B 3/004

(57) ABSTRACT

A storage unit comprises sidewalls and a base. A lid is connected to one of the sidewalls and movable between a first open position and a second closed position. The sidewalls and base defined an inner space. The storage unit may include integrated wheels at or near the confluence of the base and at least one of the sidewalls for rolling the storage unit over a surface. Organization components are provided for selective and releasable placement within the inner space for compartmentalizing the inner space into a desired configuration.

### CROSS-REFERENCE TO RELATED APPLICATIONS

This application claims the benefit of U.S. Provisional Patent Application No. 62/767,449 filed Nov. 14, 2018, the contents of which are incorporated herein in their entirety.

### FIELD AND BACKGROUND OF THE INVENTION

This invention relates to a storage unit. More particularly, the invention is for a storage unit which may serve as a deck box, and which is designed and constructed to facilitate organized storage ability, as well as improved movability. The storage box of the invention may be used for both indoor and outdoor storage, although it has many benefits which make it ideal for outdoor use.

Further, the storage box of the invention is one which may be ergonomically designed so that it is user-friendly, and can be moved and packed in a manner suitable for easy mobility and maneuverability.

### SUMMARY OF THE INVENTION

According to one aspect of the invention, there is provided a storage unit comprising: a base; sidewalls mounted on the base; a lid connected to one of the sidewalls and movable between a first open position and a second closed position; an inner space defined by the sidewalls and base; integrated wheels at or near the confluence of the base and at least one of the sidewalls for rolling the storage unit over a surface; and organization components for selective and releasable placement within the inner space for compartmentalizing the inner space into a desired configuration.

Preferably, the storage unit comprises four sidewalls, each side wall being substantially perpendicular to its adjacent side wall. The lid may be pivotally connected to one of the sidewalls along an edge thereof by at least one hinge, the lid further including securing means for holding the lid in the open or a partially open position. In one embodiment, the securing means comprises a telescoping lid strut. Preferably, strengthening brackets are positioned at the junction of adjacent sidewalls and at the junction of each side wall with the base.

In one form of the invention, the integrated wheels comprise a pair of spaced apart wheels at the confluence of the base and one of the sidewalls. The integrated wheels may include a locking mechanism so as to selectively prevent rotation of the wheels and movement of the storage unit when the wheels are locked. The spaced apart wheels may be dynamic and universally rotating wheels.

The storage unit may have a load bearing handle, which may preferably be constructed into one of the side walls and located on an opposite side of the storage unit to that of the integrated wheels, and which is an ergonomically and mechanically configured load bearing handle.

The storage unit may have a lid handle formed along an edge of the lid to facilitate the opening or closing of the lid. The lid may have an outer surface and an inner surface, the inner surface comprising downwardly extending lattice work.

In one embodiment, the organization components comprise at least one partition wall, and slots or tracks located in or on an inner surface of the sidewalls, the location of the tracks defining a distance therebetween substantially corresponding to the size of the partition wall. Also, at least one track may comprise a movable bracket which can be selectively placed relative to the inner surface of the sidewall, the bracket having means for releasably attaching to the sidewall and receiving members for accommodating an edge of the partition wall.

There may be a plurality of partition walls and a plurality of tracks formed in or on the inner surface of the sidewalls, whereby a plurality of partition walls are inserted in the inner space of the storage unit simultaneously to achieve a desired multiple compartmentalized configuration. The partition walls may have different heights whereby an upper edge thereof is located below the lid and defines an upper space between the upper edge of the partition wall and the lid.

In a further embodiment, the storage unit comprise a tray having a substantially horizontal surface, and receivers for supporting the tray within the inner space. The tray may further comprise sidewalls including handles for facilitating movement and transportation of the tray. The receivers may comprise at least a portion of the upper edge of at least one partition wall. Alternatively, or additionally, the receivers may comprise brackets selectively placed on the sidewalls, the brackets having flanges for receiving the tray. There may be a plurality of trays.

In one embodiment, the partition wall is stepped and comprises a first upper edge and a second upper edge, the first and second upper edges being positioned at different heights within the inner space when the partition wall is located therein. Further, a plurality of trays may be stacked one above the other within the inner space of the storage unit. At least one of the plurality of trays may be of a different size to at least one other of the plurality of trays.

According to another aspect of the invention, there is provided a storage unit comprising: a base; sidewalls having an inner surface and an outer surface mounted on the base; a lid connected to one of the sidewalls and movable between a first open position and a second closed position; an inner space defined by the sidewalls and base; and organization components for selective and releasable placement within the inner space for compartmentalizing the inner space into a desired configuration.

Preferably, the organization components comprise at least one partition wall selectively located within the inner space. There may be tracks formed in or on the inner surface of the sidewalls for releasably connecting and holding the partition wall. The organization components may also comprise a tray, the tray having a base and sidewalls, and a handle formed in at least one sidewall. In one form, the tray is supported within the inner space by a bracket attached to the inner surface of the sidewalls.

According to yet a further aspect of the invention there is provided a method of constructing a storage unit comprising: providing a base; mounting sidewalls on the base which extend upwardly therefrom, the side walls and base defining an inner space; connecting a lid to one of the sidewalls which is movable between a first open position and a second closed position; attaching and integrating wheels at or near the confluence of the base and at least one of the sidewalls for rolling the storage unit over a surface; and selectively installing organization components within the inner space for compartmentalizing the inner space into a desired configuration.

Selectively installing organization components may comprise positioning of at least one partition wall within the inner space. It may also comprise positioning of at least one tray within the inner space.

According to one aspect of the invention, there is thus provided a storage unit having sidewalls, a base, and a lid movable between an open condition and a closed condition, all defining an inner space, the storage unit further comprising integrated wheels for rolling the storage unit over a surface, and organization components for releasable insertion and mounting within the inner space.

Preferably, the storage unit has a square or rectangular profile, and may further comprise a load-bearing handle positioned based on the location of the wheels to facilitate moving the storage unit over a surface. However, the storage unit may be of other shapes and sizes, such as corner pieces, according to need and the nature of the storage for which it will be used.

In one embodiment of the invention, the organization components may comprise one or more utility trays which may be positioned and held within the inner space. Furthermore, the organization components may also comprise partitions or barriers which may be selectively located within the inner space to define and demarcate smaller areas or spaces within the inner space and which are configured according to the needs of the user, and the requirements based on the nature of the items which are stored.

In most cases, conventional storage boxes simply act as a large storage bin, and may comprise, for example, a square or rectangular shaped structure defining an open space which is not divided or otherwise demarcated. A lid or other form of access is provided so that the open space can be exposed for loading or unloading items which are located within the space. For practical purposes, these storage units sometimes devolve into a dumpsite, with items thrown in randomly in a disorganized and difficult to retrieve manner. This is because the open space presented has few or no organization components which allow the stored items to be specifically or optimally located in the inner space to make best use of this space, and to make them available for easier identification and retrieval when needed. Thus, a typical storage unit is one where the stored items cannot be easily accessed or arranged.

Another common problem with conventional storage boxes is that as they become filled with items which have been stored therein, the weight of the storage box and the stored items in combination make it extremely difficult or near impossible to move the unit. The storage box thus cannot be conveniently lifted, let alone steered or guided into another desired location by the user. Therefore, moving a heavy and fully loaded storage unit may require the strength of several users and assistants, or even some form of handling equipment or machinery in order to relocate the storage unit to a different position.

Conventional storage units are therefore typically simple box type structures defining a general space for receiving and storing items. Such storage units will typically have no ergonomical or mechanical structures or features associated therewith which are intended to facilitate easier movement when the storage unit needs to be relocated.

In accordance with one aspect of the invention, the present invention therefore provides a storage unit having mechanical features and structures to assist movement and relocation, especially when the storage unit contains items of considerable weight, and which would otherwise make relocating the unit very difficult.

The storage unit of the invention may preferably comprises one or more load-bearing handles strategically located on the storage unit. In one form, these load-bearing handles are selectively located on the box in positions which would improve their mechanical load-bearing abilities, and also be positioned on or around the storage unit at points which make them easily reachable by a user in a more comfortable and ergonomically convenient manner. Thus, while handles on many current or conventional boxes may comprise just a small notch, recess or other simple structure on each side of the storage unit, which may make moving the unit difficult and even cause physical damage to the user, the present invention comprises handles or similar structures which address these disadvantages, making the storage unit more mobile.

### BRIEF DESCRIPTION OF THE DRAWINGS

In the drawings:

FIG. 1 is a front perspective view of a storage unit in accordance with one aspect of the invention, including wheels;

FIG. 2 is a rear perspective view of the storage unit illustrated in FIG. 1 including a load-bearing handle;

FIG. 3 illustrates a storage unit in accordance with the invention, showing the lid open and the use of storage trays within the unit;

FIG. 4 is a perspective view of the storage unit as shown in FIG. 3 of the drawings, with the trays removed to illustrate partition plates within the storage unit; and

FIG. 5 is a perspective exploded view of a storage unit in accordance with the invention, with the lid open, and illustrating various storage and organizational components for use within the storage space.

### DETAILED DESCRIPTION OF THE INVENTION

Reference is now made to the drawings accompanying this specification, showing various embodiments of a storage unit configured in accordance with the present invention.

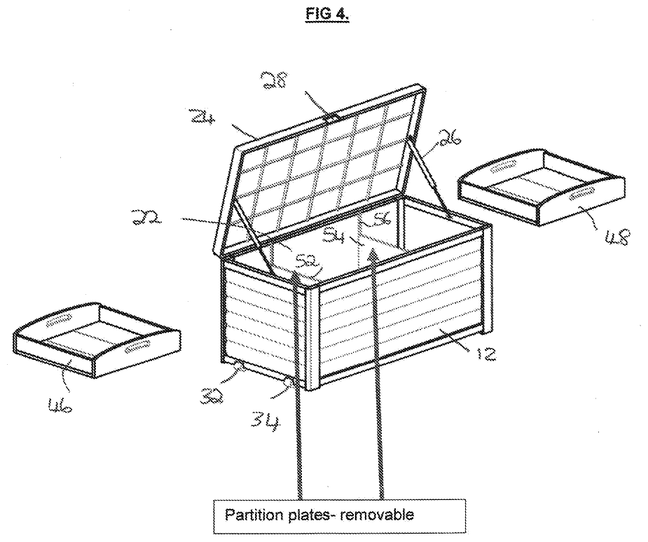

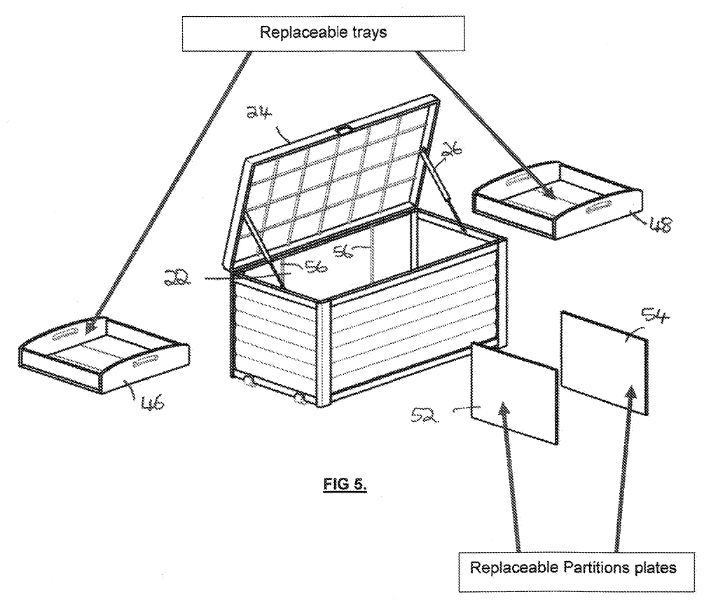

In FIG. 1 of the drawings, there is shown a storage unit 10 including a front wall 12, a rear wall 14, opposing sidewalls 16 and 18, and a base 20. All of these components define an inner space 22, best seen in FIGS. 4 and 5 of the drawings. The storage unit 10 of the invention may also be known as a deck box, a patio box, or leisure furniture, to mention some alternatives names.

The storage unit 10 includes a lid 24, which can be moved between an open and closed position in order to provide access to the inner space 22. In these drawings, the lid 24 is connected by a plurality of hinges to the rear wall 14, and pivots about these hinges when moving between the open and closed condition. It will be seen that pneumatic or hydraulic jacks or brackets 26 are provided, which not only are able to keep the lid sustained in the open position, but may also be configured so that they will hold the lid open in any selected position between completely closed and completely opened, as desired by the user. This may be useful and convenient when the storage unit is in a location where there is insufficient height to open the lid 24 completely.

The lid 24 includes a notch 28 or handle, in the form of a recess to facilitate gripping the lid 24 for the purposes of opening and closing it. While the illustrated gripping mechanism is in the form of the notch 28, any other suitable device or structure may be used for this purpose.

At the bottom of the side wall 16, there is mounted a pair of wheels 32 and 34. In a preferred form of the invention, these wheels 32 and 34 are dynamic and universally rotating wheels. Such wheels may be configured so that they can roll or move in any direction, so that the storage unit 10 may roll on the wheels in a direction which is parallel to its longitudinal edge, a direction which is normal to its longitudinal edge, or anything in between. Of course, it will be appreciated that different types of wheels may be mounted for different situations, and that the actual mounting point of the wheels 32 and 34 may be different from that illustrated in the drawings. Moreover, wheels may be located at both ends, or at the bottom of both side walls 16 and 18, enabling the storage units to roll over a surface in its general standing condition. In such case, at least some of the wheels may have braking mechanisms associated there with, so that some of the wheels can be fixed to prevent rolling of the storage unit when no movement of the unit is desired.

The storage unit 10 in the drawings thus show a feature which is absent in most of the storage units or boxes currently available, namely, the universally rotating wheel which may be integrally built into the storage unit itself. The wheels can be outdoor rated, or they may be more suitable for indoor use. The wheels may be comprised of metal, nonmetal, or any other available materials type which is able to withstand the required static load. The wheels are placed or mounted with respect to the storage unit 10 in such a way that this will preferably allow the user to push or pull the box with relative ease when in a fully loaded condition, and need not be picked up or lifted together with potentially heavy contents which may be present in the inner space of the storage unit 10.

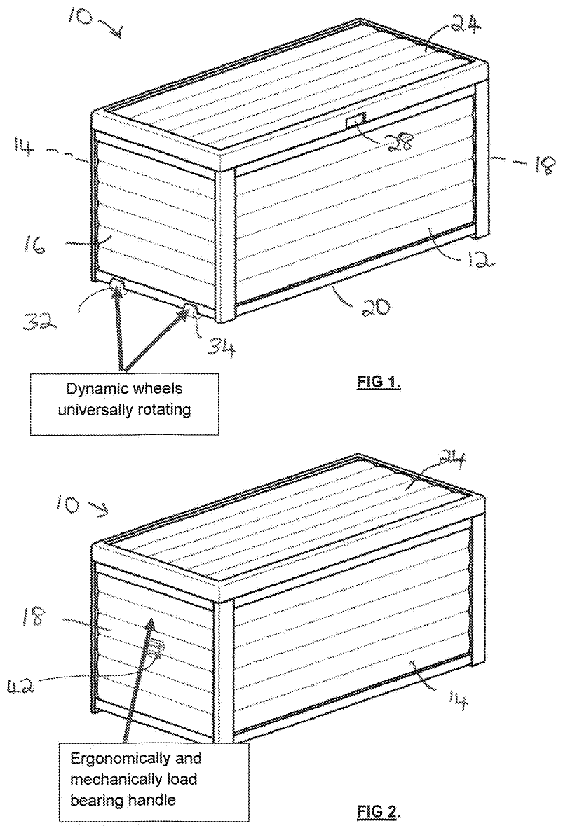

Reference is now made to FIG. 2 of the drawings, which shows a rear perspective view of the storage unit 10 illustrated in FIG. 1 of the drawings. FIG. 2 illustrates the presence of an ergonomically and mechanically configured load-bearing handle 42, which in this embodiment is mounted on the side wall 18 of the storage unit 10. The handle 42 is preferably one of the type which can be folded flat against the side wall 18, so that it will not be an obstruction in normal use, but can be pivoted outwardly and easily grasped by the user when needed. It will be seen that the handle 42 is mounted on the side wall 18 opposite to that the side wall 16 upon which the wheels 32 and 34 are mounted. Thus, the handle 42 is located in a manner which allows the user to pull the storage unit 10 in the fully loaded condition, also rolling on the wheels 32 and 34, enabling the user in most instances to move the storage unit 10 without assistance of other people, and without the use of any material handling equipment or machinery which may typically be needed for moving heavy objects.

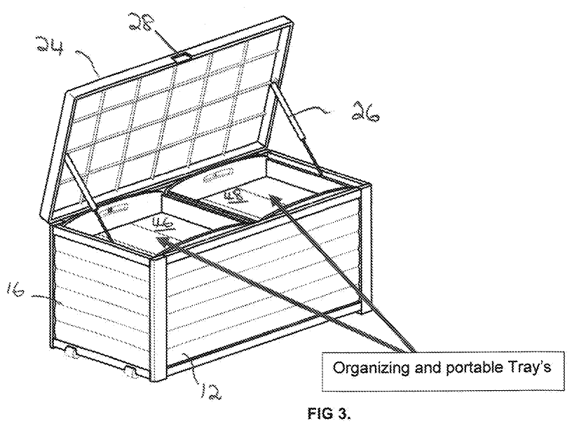

Reference is now made to FIG. 3 of the drawings. In FIG. 3 of these drawings, the lid 24 has been raised from the closed to the open position, allowing access to the inner space 22 as defined by the storage unit 10. FIG. 3 illustrates the positioning of two organizing and portable trays 46 and 48 which are placed at the top of the inner space 22, and present storage areas for smaller items. While two trays are shown in the present embodiment, the invention is not limited to the use of two such trays and any number of trays, with different dimensions including width and depth, may be used. The trays may be connectable to each other by clasps or other mechanical connectors, which are of the releasable type so that the user can determine how the trays may be moved, stored or unpacked, whether individually or in groups. The trays 46 and 48 are, of course, utilized to organize and carry items easily, allowing for easy identification and retrieval when desired. Further, the trays, which have slots in their opposing side walls for easy carrying, can also be used independently of the storage unit 10, for transporting or serving items in other different or conventional manners. Furthermore, the trays may have small compartments or closed-off areas arranged thereon, which may be individually sized to contain specific items, such as jewelry, electronics, keys, to name a few examples.

FIG. 4 of the drawings illustrates the storage unit 10 as shown in FIG. 3 of the drawings, but wherein the trays 46 and 48 have been removed, thereby providing access to the inner space 22 available as storage space below the trays 46 and 48. It will be seen that the storage unit 10 illustrated contains two vertical partitions 52 and 54. The front wall 12 and the rear wall 14 each have corresponding vertical slots 56 so that the edge of a partition 52 or 54 may be securely located within the inner space 22 by sliding it up and down in the cooperating slots 56. Slots may also be positioned which are not necessarily vertical, so that a storage space can be created which is not of a square or rectangular configuration.

It should be noted that, while two partitions 52 and 54 are shown in these drawings, the invention is not limited to this number. There may be any number of convenient partitions which can be placed within the inner space 22, and a plurality of slots 56 arranged to receive them. The partitions may be parallel to the side walls 16 and 18, or parallel to the front wall 12 and a rear wall 14, or a mix of both. In this regard, a partition itself may be equipped with a slot recessed therein, or mounted on the surface thereof, so that a partition itself can form a base for connection of other partitions. Such other partitions may extend between partitions, or between a partition and one of the sidewalls, front wall or rear wall of the storage unit 10 itself.

FIGS. 4 and 5 of the drawings shows that the inner space 22 inside the storage unit 10 is partitioned in adjustable and selectable manners. These structures address a substantial disadvantage of many other conventional storage boxes. Instead of being a gaping empty box without the ability to organize, the storage unit 10 of the invention has flexible partitioning options which allows the user to organize stored items in the inner space based on the nature, size, or other feature of the item. Since these partitions or areas are adjustable, smaller or larger spaces can be created and adjusted accordingly. If the user should need the entire box, the partitions can be removed from their positions dividing up the inner space 22, and stacked horizontally inside the box, where they take up very little room, and will not become separated from the storage unit or lost over time.

FIG. 5 of the drawings shows an exploded view of the storage unit 10, as seen in the previous figures, with the lid 24 open, as well as the trays 46 and 48, and the partitions 52 and 54, removed from the inner space 22 of the storage unit 10. It is to be noted that both the trays and the partitions are replaceable, or interchangeable, with those of other sizes, shapes or general dimensions. Further, partition plates may have less height, so that instead of a single layer of trays being stored, as shown in the drawings, two or more layers of trays may be stacked one on top of the other, either over the entire inner space or a selected portion thereof. Replaceable partitions 52 and 54 may also have different heights, so that an appropriate partition is selected depending upon the number of trays required to be stored above it. In one form of the invention, the base of each of the trays rests on a partition so that it will stay in position near the top of the inner space 22. However, there may be other mechanisms in place for securing the trays in a desired position, such as hooks, brackets, a shelf, flange or beading around all or a part of the inner surfaces of the walls of the storage unit 10, or such other structure which will achieve this purpose.

FIG. 5 also illustrates the situation that, where all of the trays and partition plates are removed, the box will present a large open in a space the entirety of which can be used in a conventional manner. However, when needed, the partition plates and utility trays can be reinstalled into the box in many different forms and configurations so as to enable the user to better organize and utilize the space optimally for storage purposes.

It should be appreciated that the invention is not limited to the precise constructional details described and illustrated herein. Various changes and different embodiments can be utilized, all of which would continue to operate within the scope of the present invention.

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

1. A storage unit comprising:
a base;
sidewalls mounted on the base;
a lid connected to one of the sidewalls and movable between a first open position and a second closed position;
an inner space defined by the sidewalls and base;
integrated wheels at or near the confluence of the base and at least one of the sidewalls for rolling the storage unit over a surface; and
organization components for selective and releasable placement within the inner space for compartmentalizing the inner space into a desired configuration.

2. A storage unit as claimed in claim 1 comprising four sidewalls, each side wall being substantially perpendicular to its adjacent side wall.

3. A storage unit as claimed in claim 1 wherein the lid is pivotally connected to one of the sidewalls along an edge thereof by at least one hinge, the lid further including securing means for holding the lid in the open or a partially open position.

4. A storage unit as claimed in claim 3, wherein the securing means comprises a telescoping lid strut.

5. A storage unit as claimed in claim 1 further comprising strengthening brackets positioned at the junction of adjacent sidewalls and at the junction of each side wall with the base.

6. A storage unit as claimed in claim 1 wherein the integrated wheels comprise a pair of spaced apart wheels at the confluence of the base and one of the sidewalls.

7. A storage unit as claimed in claim 6 wherein the integrated wheels include a locking mechanism so as to selectively prevent rotation of the wheels and movement of the storage unit when the wheels are locked.

8. A storage unit as claimed in claim 1 further comprising a load bearing handle.

9. A storage unit as claimed in claim 8 wherein the load bearing handle is constructed into one of the side walls and located on an opposite side of the storage unit to that of the integrated wheels.

10. A storage unit as claimed in claim 8 wherein the load bearing handle is an ergonomically and mechanically configured load bearing handle.

11. A storage unit as claimed in claim 6 wherein the spaced apart wheels are dynamic and universally rotating wheels.

12. A storage unit as claimed in claim 1 further comprising a lid handle formed along an edge of the lid to facilitate the opening or closing of the lid.

13. A storage unit as claimed in claim 1 wherein the lid has an outer surface and an inner surface, the inner surface comprising downwardly extending lattice work.

14. A storage unit as claimed in claim 1 wherein the side walls are comprised of a pair of opposing long walls, and a pair of opposing short walls, the long walls and short walls defining a substantially rectangular shaped inner space, each of the walls having an inner and outer surface.

15. A storage unit as claimed in claim 1 wherein the organization components comprise at least one partition wall, and slots or tracks located on an inner surface of the sidewalls, the location of the tracks defining a distance therebetween substantially corresponding to the size of the partition wall.

16. A storage unit as claimed in claim 1 wherein the organization components comprise at least one partition wall, and tracks formed in or on the inner surface of the sidewalls, the tracks being located so as to define a distance therebetween substantially corresponding to the size of the partition wall.

17. A storage unit as claimed in claim 16 wherein at least one track comprises a movable bracket which can be selectively placed relative to the inner surface of the sidewall, the bracket having means for releasably attaching to the sidewall and receiving members for accommodating an edge of the partition wall.

18. A storage unit as claimed in claim 16 comprising a plurality of partition walls and a plurality of tracks formed in or on the inner surface of the sidewalls, whereby a plurality of partition walls are inserted in the inner space of the storage unit simultaneously to achieve a desired multiple compartmentalized configuration.

19. A storage unit as claimed in claim 15 wherein the partition walls have different heights whereby an upper edge thereof is located below the lid and defines an upper space between the upper edge of the partition wall and the lid.

20. A storage unit as claimed in claim 19 further comprising a tray having a substantially horizontal surface, and receivers for supporting the tray within the inner space.

21. A storage unit as claimed in claim 20 wherein the tray further comprises sidewalls including handles for facilitating movement and transportation of the tray.

22. A storage unit as claimed in claim 20 wherein the receivers comprise at least a portion of the upper edge of at least one partition wall.

23. A storage unit as claimed in claim 20 wherein the receivers comprise brackets selectively placed on the sidewalls, the brackets having flanges for receiving the tray.

24. A storage unit as claimed in claim 20 comprising a plurality of trays.

25. A storage unit as claimed in claim 15 wherein the partition wall is stepped and comprises a first upper edge and a second upper edge, the first and second upper edges being positioned at different heights within the inner space when the partition wall is located therein.

26. A storage unit as claimed in claim 21 wherein a plurality of trays may be stacked one above the other within the inner space of the storage unit.

27. A storage unit as claimed in claim 26 wherein at least one of the plurality of trays is of a different size to at least one other of the plurality of trays.

28. A storage unit comprising:
a base;
sidewalls having an inner surface and an outer surface mounted on the base;
a lid connected to one of the sidewalls and movable between a first open position and a second closed position;
an inner space defined by the sidewalls and base; and
organization components for selective and releasable placement within the inner space for compartmentalizing the inner space into a desired configuration.

29. A storage unit as claimed in claim 28 wherein the organization components comprise at least one partition wall selectively located within the inner space.

30. A storage unit as claimed in claim 29 further comprising tracks formed in or on the inner surface of the sidewalls for releasably connecting and holding the partition wall.

31. A storage unit as claimed in claim 28 further comprising a tray, the tray having a base and sidewalls, and a handle formed in at least one sidewall.

32. A storage unit as claimed in claim 31 wherein the tray is supported within the inner space by a bracket attached to the inner surface of the sidewalls.

33. A storage unit as claimed in claim 32 further comprising at least one partition wall, and wherein the tray is supported by at least one of the partition walls.

34. A storage unit as claimed in claim 33 wherein the partition wall has a first height surface edge and a second height surface edge, at least one of the first and second height surface edges supporting a tray.

35. A method of constructing a storage unit comprising:
providing a base;
mounting sidewalls on the base which extend upwardly therefrom, the side walls and base defining an inner space;
connecting a lid to one of the sidewalls which is movable between a first open position and a second closed position;
attaching and integrating wheels at or near the confluence of the base and at least one of the sidewalls for rolling the storage unit over a surface; and
selectively installing organization components within the inner space for compartmentalizing the inner space into a desired configuration.

36. A method as claimed in claim 35 wherein selectively installing organization components comprises positioning of at least one partition wall within the inner space.

37. A method as claimed in claim 35 wherein selectively installing organization components comprises positioning of at least one tray within the inner space.
